(19) United States
(12) Patent Application Publication
(10) Pub. No.: US 2026/0001421 A1
(43) Pub. Date: Jan. 1, 2026

(54) AMELIORATING EMMISSIONS FROM MOBILE TRAILER REFRIGERATION UNITS AND THERMAL MANAGEMENT OF PORTABLE BATTERY POWER SUPPLY

(71) Applicant: COULOMB SOLUTIONS, INC., LIVERMORE, CA (US)

(72) Inventors: DAVID MICHAEL MAZAIKA, MILPITAS, CA (US); LINING ZHOU, MILPITAS, CA (US); NICOLAS BOUCHON, Livermore, CA (US)

(73) Assignee: COULOMB SOLUTIONS, INC., LIVERMORE, CA (US)

(21) Appl. No.: 19/212,581

(22) Filed: May 19, 2025

Related U.S. Application Data
(60) Provisional application No. 63/664,665, filed on Jun. 26, 2024.

(51) Int. Cl. B60L 53/20; B60H 1/00; B60H 1/32; B60L 58/26; B60P 3/20

(52) U.S. Cl. CPC B60L 53/20; B60H 1/00321; B60L 58/26; B60P 3/20; B60H 2001/3236; B60L 2200/28; B60L 2210/10

(57) ABSTRACT

Disclosed herein are methods and systems to leverage a mobile cooling infrastructure to temperature control mobile electrical power systems including placing a heat exchange module in thermal communication with a cooled environment within a mobile refrigerated trailer and using cooled environment to cool fluid within a heat exchange means, wherein the heat exchange means is in thermal communication with one or more heat producing components of a charging, drive, and power system of a mobile trailer and/or tractor.

### RELATED APPLICATION

This Application is a U.S. Non-Provisional Application of U.S. Provisional Application No. 63/664,665, filed Jun. 26, 2024. The disclosure of this priority is incorporated by reference herein in its entirety.

### BACKGROUND OF THE DISCLOSURE

### Field of the Disclosure

The present disclosure relates generally to reducing emissions from trailer refrigerator units on mobile vehicles and temperature management of portable battery power supplies system in vehicles.

### RELATED ART

Vehicles that run on battery power, such as hybrid vehicles and electric vehicles, are becoming increasingly popular. Such vehicles provide a number of advantages over vehicles that do not utilize battery power. For example, such vehicles save drivers money, as no fuel is required. Such vehicles are also environmentally friendly as they do not emit pollutants. Larger commercial size vehicles have greater energy requirements and a by-product of the energy requirements is heat. Moreover, larger commercial vehicle and in particular refrigerated trailers transported by tractors have enormous legacy systems in service which also add to pollution of the airways. Therefore, methods to make legacy non electric vehicle less polluting and to improve efficiency of electrical commercial vehicles are desirable.

### DISCLOSURE

Aspects of systems and methods are disclosed herein to maintain refrigeration in a mobile trailer while charging an electric vehicle, including connecting a stationary high voltage power supply to an input interface on an electric vehicle and distributing the high voltage power to charge batteries of said vehicle. A controller is configured to distribute said high voltage to power a refrigeration unit in fluid communication with a refrigerated trailer. In some instances an onboard battery charger to receive alternating current (AC) power and output provide direct current (DC) power to charge batteries is included. In some instances the on board converter provides DC power to the refrigeration unit. In some instances a buck converter to decrease voltage and increase current as needed to charge or power one or more of said batteries and refrigeration unit. In some instances a cooling means to cool one or more of the high power components and batteries in a mobile platform is included.

Aspects of systems and methods are disclosed herein to leverage a mobile cooling infrastructure to temperature control mobile electrical power systems including placing a heat exchange module in thermal communication with a cooled environment within a mobile refrigerated trailer and using cooled environment to cool fluid within a heat exchange means. Wherein the heat exchange means is in thermal communication with one or more heat producing components of a charging, drive, and power system of a mobile trailer and/or tractor.

Aspects of systems and methods are disclosed herein to leverage a mobile cooling infrastructure to temperature including one of connecting a stationary high voltage power supply to an input interface on an electric vehicle for charging the batteries of said mobile vehicle and connecting a battery power supply in said mobile vehicle distributing to a trailer refrigeration units; supplying high voltage to power the trailer refrigeration unit; and, wherein the electrical powering of the (TRU) by-passes a diesel motor which is the alternate source of power to the TRU thereby reducing pollutants produced during operation of said TRU.

Aspects of systems and methods are disclosed herein maintain refrigeration in a mobile platform including connecting a stationary high voltage power supply to an input interface on a mobile platform and distributing the high voltage power to charge batteries associated with said platform. having a bidirectional converter in signal communication with a controller. the controller is configured to control the bidirectional converter to distribute said high voltage to power to one or more of a refrigeration unit in fluid communication with a refrigerated enclosure and a mobile battery power supply. In some instances a boost or buck converter to adjust voltage and current as needed to charge or power one or more of said batteries and refrigeration unit. In some instances a cooling means is included. In some instances the control receives input from one or voltage and/or current sensors and prioritizes providing power to the TRU to be at or below a threshold amount. in some instances the controller is configured to supply power below the threshold amount drawn by the TRU to the bidirectional converter to at least charge the mobile battery power supply.

Aspects of systems and methods are disclosed herein of leveraging a mobile cooling infrastructure to temperature control mobile electrical power systems the method including placing a heat exchange module in thermal communication with a cooled environment inside a mobile refrigerated trailer, using the cooled environment to cool fluid within a heat exchange means. And, wherein the heat exchange means is in thermal communication with one or more heat producing components of a charging, drive, and power system of a mobile trailer and/or tractor. In some instances at least a portion of the heat exchange module is on of outside the enclosure, partially inside the enclosure and inside the enclosure.

Aspects of systems and methods are disclosed including maintaining refrigeration in a mobile enclosure and generating less pollution in the environment, the method comprising one of connecting a stationary high voltage power supply to an input interface on a mobile electric platform for charging the batteries of said mobile electric platform and connecting a battery power supply of said mobile platform and distributing power to a trailer refrigeration unit (TRU) and wherein the electrical power is supplied to run the cooling components in the (TRU), and wherein the use of electricity to power the TRU by-passes the alternate fuel combusting engine source of power to the TRU. In some instances said by-pass reduces pollutants produced during operation of said alternate fuel combusting engine source of power to the TRU.

This Disclosure is provided to introduce a selection of concepts in a simplified form that are further described below in the Disclosure. This Summary is not intended to identify key features or essential features of the claimed subject matter, nor is it intended to be used to limit the scope of the claimed subject matter. Furthermore, the claimed subject matter is not limited to features that solve any or all disadvantages noted in any part of this disclosure.

### FIGURES

The following detailed description is better understood when read in conjunction with the appended drawings. For the purposes of illustration, examples are shown in the drawings; however, the subject matter is not limited to specific elements and instrumentalities disclosed. In the drawings:

FIG. 1A shows aspects of a system overview of a method and system for powering a Trailer Refrigeration Unit (TRU) during recharging of a tractor trailer high voltage battery power supply.

FIG. 1B shows aspects of some key components of the method and system for powering a Trailer Refrigeration Unit (TRU) during recharging of a tractor trailer high voltage battery power supply.

FIG. 2 shows an overview of aspects of a method and system for powering a Trailer Refrigeration Unit (TRU).

FIG. 3 is a system overview of utilizing an existing mobile infrastructure for temperature controls of heat producing devices and systems in a mobile power system.

FIG. 4 shows an overview of aspects of a method and system for leveraging an existing mobile infrastructure for temperature controls of one or more of a charging switching system and the batteries

### FURTHER DISCLOSURE

Presently disclosed are aspects of systems and methods for high-power charging of electric vehicle batteries and/or for electrically powering an alternative to the traditional combustion power supply of a refrigeration unit for maintaining temperature in a mobile enclosure including but not limited to vehicles, containers, shipping containers, mobile containment for passengers, animals or products. The interior of a refrigerated enclosure 20 (also referred to as a mobile platform, trailer and vehicle) when in service must be kept within a required temperature range. The requirement is necessary even when said enclosure 20 is parked. Traditionally diesel powered generators have been used to maintain the operation of the refrigeration unit for the enclosure in transport and/or when parked or idle.

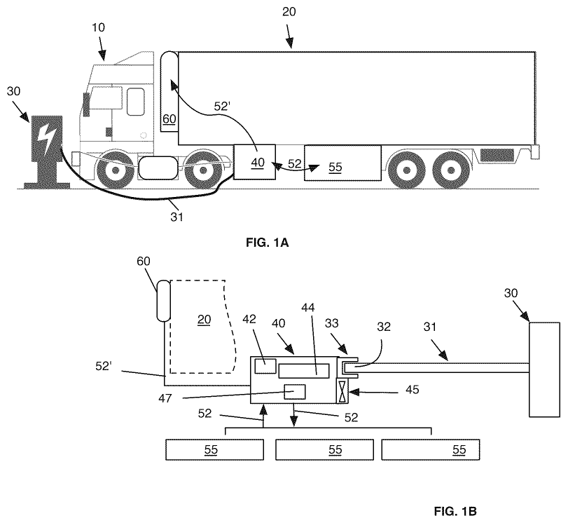

The instant disclosure provides a cleaner alternative to combustion of fossil fuel to power said refrigeration unit. FIGS. 1A and 1B show aspects of a vehicle and refrigerated trailer with this environmentally cleaner method and system. A tractor 10 is coupled to a trailer 20. The tractor-trailer combination is connected to a high voltage, such as 480 VAC, power supply 30 to high power charge the batteries. The high voltage ground or stationary power supply 30 is connected to a high voltage supply line 31 which has a first interface 32 that mates with a second interface 33 to an on board battery charger system (OBC) 40 (which may be bi-directional AC or DC or provide AC at high voltage and provide DC power 52 to charge batteries 55. The on board (battery) charger has a switching means including at least an AC to DC converter 42 buck (or boost) converter 44 to adjust voltage and increase current as needed, a thermal control means 45 to remove add or heat for the charging system components and batteries is a part of the system. The thermal control means may include fluids in a closed loop which are well known in the art. The system includes one or more controllers 47 whereby DC power 52 may be supplied directly to batteries 55 being charged and/or said refrigeration unit. A switching means whereby appropriate amounts of AC to power 52′ the trailer refrigeration unit (TRU) 60 is supplied. Accordingly, instead of utilizing a traditional diesel power supply to power said refrigeration unit for the trailer, the diesel motor may be eliminated or the diesel engine can be maintained and in some instances by-passed.

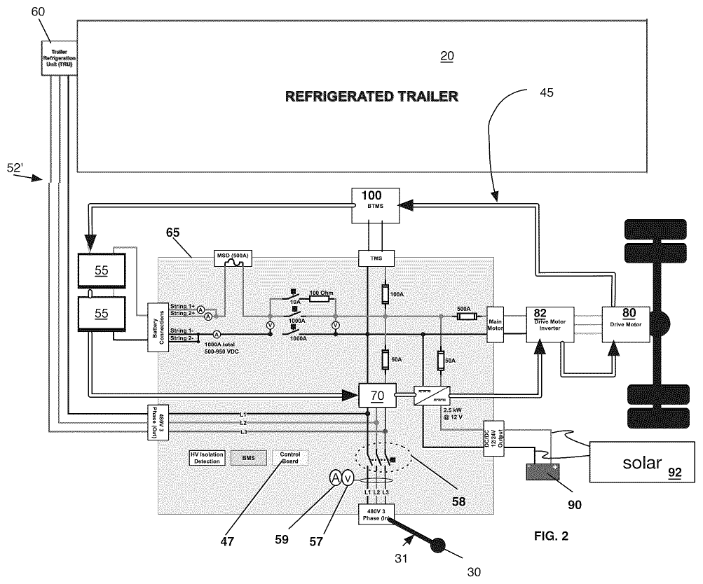

FIG. 2 illustrates additional aspects of vehicle and refrigerated trailer with environmentally cleaner method and system. A switching means 48 in a one position connects the TRU to the high voltage battery supply 55 and in another position connect the TRU to the stationary high voltage power supply 30. In this instance the traditional TRU is powered by a diesel engine which exhausts pollutants. By way of the disclosed method and system usage of the diesel engine to power the TRU can be omitted. A combusting engine such as a diesel engine may be attached to a TRU or included in older mobile platforms and may form a part of the TRU system. Withing the Tru are components (known in the art) which are powered by, or driven (in the case of pumps and compressors) by said combusting engine. However, the disclosed invention can be selectively used to by-pass existing combusting engines on an as needed basis. As described above, the disclosure teaches both charging the high voltage battery power supply and can at the same time power the TRU to maintain the refrigeration system for the enclosure. In some instances the high battery power supply and high voltage system disclosed herein can provide electricity for motive power of an electric vehicle and at the same time provide high voltage power to the TRU and/or also by-pass the use of a combusting engine such as a diesel engine even during motive transportation while maintaining operation of refrigeration system. In some instances a control system, using processors and computing devices utilizing code/software in said hardware, decisions based on parameters such as navigation plan, energy requirements, pollution surcharges on roadways and the like when to use power from the batteries to power the TRU and when to use a diesel engine to power the TRU. In other instances the mobile platform or vehicle is non electrical for motive. However the battery high voltage supply and charging switching system is electrical TRU function at those times or locations wherein electrical TRU is preferred.

The charging and switching system 65 and the batteries 55 generate heat therefore the thermal control means 45 is important to at least one of improve efficiency, maintain system function and optimize system function for the charging and to lengthen the life of battery system(s). A battery thermal management system of “BTMS” 100 which can heat or cool a fluid in a thermal control means is shown to be in thermally communication with the thermal control means (closed fluid line). Said BTMS is important to maintain optimal temperature for the batteries in different ambient temperature situations. However, such thermal management systems can add considerable cost to an electrical power system whether for the TRU, motive or both. In some instances the thermal control includes a chiller, a fluid heat exchanger with pumps in addition to fans and cooling fins.

In these exemplary there is a bidirectional HVDC to 480 VAC system 70. HVAC 480 is not a limitation and those of ordinary skill in the art will understand that the disclosure relates to a high voltage AC system and the 480 VAC is an exemplar and not intended as a limitation. One or more voltage sensor(s) 57 measure if the stationary power is supplying the high voltage AC for charging and or for the TRU.

In some instances if stationary power is supplied then the trailer's onboard system does not need to draw from the batteries to supply said power to said TRU. Once the voltage sensor(s) being in signal communication with one or more controllers measure that the stationary power supply 30 is supplying energy the switching means 58 can then connect the stationary power supply to the trailer based systems such as the TRU and/or batteries.

In some instances, if the stationary power supply 30 voltage is detected, then the controller is configured to command the bi-directional converter to stop producing high voltage AC (such as, but not limited to 480 VAC). The switch is then closed to connect stationary power to the mobile platform's AC bus, where it can be used by the TRU (to cool) and the bi-directional converter (to charge batteries).

The system also includes current sensors 59 to measure the current drawn by the TRU and is configured to adjust current drawn to avoid breaking the circuit or tripping circuit breakers. In some instances the stationary power supply is a three phase 480 VAC supply at 30 A. If the TRU is drawing less than 30 A then the current sensor 59, which is in signal communication with one or more controllers, provides input of the total current drawn, the bidirectional converter 70 adjusts the amount of power drawn from the stationary power supply to be within a predefined limit of the TRU whereby the controllers in signal communication with the bidirectional battery charger limit the power provided to charge the batteries and the TRU to at or below than the predetermined limit. Said monitoring occurs in real time and the controller will dynamically adjust the battery charging to prioritize the TRU to maintain refrigeration at a predetermined value or threshold temperature.

In some instances the trailer 20 may be fitted with regenerative braking systems including at least a drive motor 80 and an inverter 82. A lower voltage battery 90 is included. Said lower voltage battery is used to power the controllers and other balance of plant components which may be necessary to utilize the charging switching system. To maintain a state of charge in the lower voltage battery 90 a photovoltaic system 92 may be part of the enclosure or TRU. Said photovoltaic system can be used to one or more of add charge to batteries and/at least partially power the TRU. In some instances the photovoltaic is used when the trailer is stationary to keep a minimum required charge in the lower voltage battery 90.

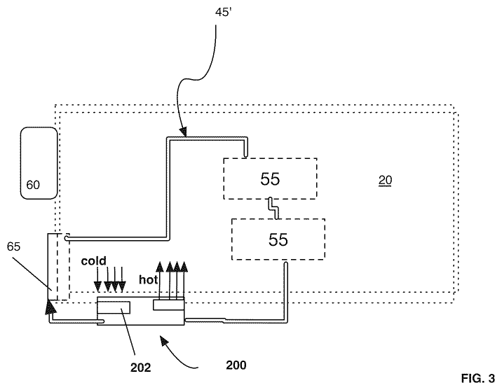

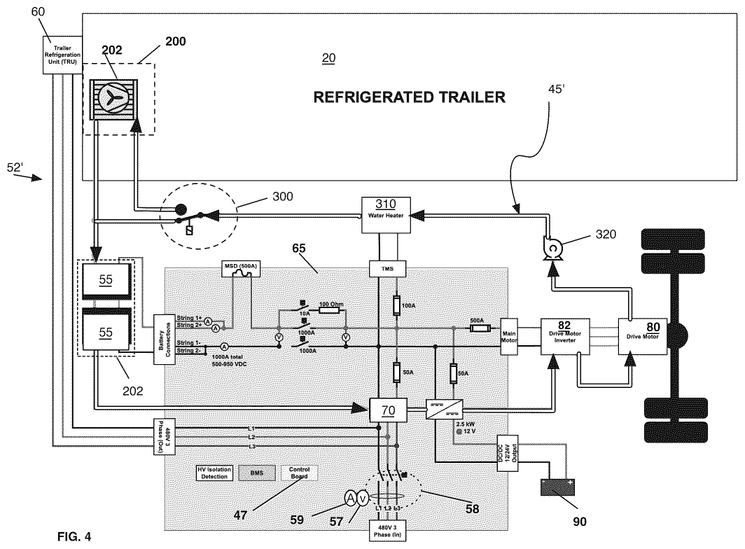

FIGS. 3 and 4 shows aspects of a system overview of utilizing an existing mobile infrastructure for temperature controls of one or more of a charging switching system and the batteries. The TRU 60 is a device to maintain a temperature within a refrigerated trailer 20. With negligible effect on the volume of the refrigerated trailer and de minims effect on the temperature within the refrigerated trailer the disclosed CSI methodology and system leverages the refrigerated trailer as a mobile infrastructure for cooling system component which generate heat and whose efficiency and/or life time is reduced if said heat is not minimized. A heat exchange module 200 FIG. 4 shows additional aspects and details of leveraging a mobile existing refrigerated infrastructure to cool one or more of a variety of motive and charging systems of a tractor (not shown) and/or refrigerated trailer with high voltage electrical systems.

One or more fans 202 and/or pumps 320 are used to direct the environment (air) in the refrigerated trailer into thermal communication with the coolant fluid in the thermal control means 45′. A valve 300 is in signal communication with a controller to by-pass the cooling when needed. For example in cold environments a battery power supply may require heat to be added and as such as fluid heating means 310 may be placed in thermal communication with the thermal control means 45′. In some instances a thermal blanket or other electrically heated wrap 330 may be placed in thermal communication around the batteries to heat them.

In other instances the valve 300 directs the fluid in the thermal control means 45″ (such as a heat exchange pipe or tube) into thermal communication with the cooled environment within the refrigerated trailer. A fan 202 is shown to direct cooled environment into thermal communication with said thermal control means. One or more pumps 320 may be used to circulate fluid in the thermal control means.

We believe any loss of cooled environment will be offset or outweighed by the improved efficiency of batteries in a motive system or batteries in a TRU power system.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

These drawings may not be drawn to scale and may not precisely reflect structure or performance characteristics of any given embodiment and should not be interpreted as defining or limiting the range of values or properties encompassed by example embodiments.

As used in the specification and the appended claims, ranges may be expressed herein as from “about” one particular value, and/or to “about” another particular value. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect.

It will be apparent to those skilled in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method of maintaining refrigeration in a mobile platform, the method comprising:
connecting a stationary high voltage power supply to an input interface on a mobile platform;
distributing the high voltage power to charge batteries associated with said platform;
a bidirectional converter in signal communication with a controller;
the controller is configured to control the bidirectional converter to distribute said high voltage to power to one or more of a refrigeration unit in fluid communication with a refrigerated enclosure and a mobile battery power supply.

2. The method of claim 1, the method further comprising a boost or buck converter to adjust voltage and current as needed to charge or power one or more of said batteries and refrigeration unit.

3. The method of claim 1, the method further comprising a cooling means.

4. The method of claim 1, wherein the control receives input from one or voltage and/or current sensors and prioritizes providing power to the TRU to be at or below a threshold amount.

5. The method of claim 4, wherein the controller is configured to supply power below the threshold amount drawn by the TRU to the bidirectional converter to at least charge the mobile battery power supply.

6. A method of leveraging a mobile cooling infrastructure to temperature control mobile electrical power systems the method comprising:
placing a heat exchange module in thermal communication with a cooled environment inside a mobile refrigerated trailer;
using the cooled environment to cool fluid within a heat exchange means;
wherein the heat exchange means is in thermal communication with one or more heat producing components of a charging, drive, and power system of a mobile trailer and/or tractor.

7. The method of leveraging a mobile cooling infrastructure to temperature control mobile electrical power systems of claim 6, wherein at least a portion of the heat exchange module is on of outside the enclosure, partially inside the enclosure and inside the enclosure.

8. A method of maintaining refrigeration in a mobile enclosure and generating less pollution in the environment, the method comprising:
one of connecting a stationary high voltage power supply to an input interface on a mobile electric platform for charging the batteries of said mobile electric platform and connecting a battery power supply of said mobile platform and distributing power to a trailer refrigeration unit (TRU);
wherein the electrical power is supplied to run the cooling components in the (TRU); and,
wherein the use of electricity to power the TRU by-passes the alternate fuel combusting engine source of power to the TRU.

9. The method of maintaining refrigeration in a mobile enclosure and generating less pollution in the environment, of claim 7, wherein said by-pass reduces pollutants produced during operation of said alternate fuel combusting engine source of power to the TRU.
